(19) United States
(12) Patent Application Publication
(10) Pub. No.: US 2017/0371424 A1
(43) Pub. Date: Dec. 28, 2017

(54) Predictive Text Typing Employing An Augmented Computer Keyboard

(71) Applicant: Jonathon Patrick Mancini, Ancaster (CA)

(72) Inventor: Jonathon Patrick Mancini, Ancaster (CA)

(21) Appl. No.: 15/536,688

(22) PCT Filed: Dec. 18, 2015
(86) PCT No.: PCT/CA2015/051344

§ 371 Date: Jun. 16, 2017

Related U.S. Application Data
(60) Provisional application No. 62/095,001, filed on Dec. 20, 2014.

(51) Int. Cl. G06F 3/023; G06F 17/27; G06F 3/02

(52) U.S. Cl. CPC G06F 3/0237; G06F 3/0219; G06F 17/276

(57) ABSTRACT

An augmented computer keyboard for inputting text into a computer is provided, where each character of the text being input is displayed on a computer screen in real time. The computer keyboard preferably has a QWERTY key layout, and has at least two additional keys which have selection functionality to select one or another of suggested text strings appearing in selected display fields on the computer screen. There is one display field for each provided additional key. The suggested text strings are presented in the respective selected display fields dynamically and in real time as each keystroke is made, and are chosen using predictive text software running on the computer. In a preferred embodiment, the additional keys are physically placed so as to be near the space bar on the computer keyboard.

### FIELD OF THE INVENTION

This invention relates to text input into a computer, and more particularly the invention is directed toward an augmented computer keyboard which, together with predictive text software running on a computer, can greatly improve the typing efficiency of the computer user. This is particularly true if the computer user is a skilled touch typist using a QWERTY keyboard layout. The invention also provides a method of text composition employing an augmented computer keyboard in real time and in dynamic communication with text predictive software running on the computer.

### BACKGROUND OF THE INVENTION

Word completion, sometimes referred to as autocomplete, and more usually referred to as text prediction, is now a feature that can be found on many web browsers, email programs, and especially word processors. More recently texting devices, such as so-called “smart phones”, provide a variety of software which accommodates text composition—anything from messages comprising no more than 140 characters up to conversations carried out by sending text to and among those joining the conversation, and up to emails and beyond. In every instance where text prediction is employed, text is being composed; that is, words are being typed and entered into the computer (such as it may be found in a smart phone), or a laptop computer, desktop computer, etc.

In general, text prediction is found on small handheld devices such as smart phones, which may either have a virtual keyboard which appears on the screen, a limited number of hardware keys such as those which are found on a telephone (typically, 12 keys) or an embedded small keyboard. Almost always, a virtual keyboard or an embedded small keyboard employs a QWERTY layout. Laptop computers and desktop computers almost always employ a full, physical computer keyboard.

It is quite usual that small handheld devices, and tablets which may have a slightly larger screen and a virtual keyboard which appears on the screen, will have some kind of text prediction whereby, after a few letters have been typed or entered, the text prediction software will suggest up to three words, any of which may be chosen. If none of those words is suitable, then the user is required to type more letters until such time as the intended word is completed, or the text prediction software has effectively “guessed” at what the intended word may be Often, the word prediction may be context related, depending on the software being run. In any event, the process may be quite slow, partly because of the speed of the processor in the handheld device, and partly because of the physical size of the device and the difficulty in actuating the appropriate virtual or physical key required to be selected in order to insert the intended word.

Most popular word processor software is intended to be run on laptop computers or desktop computers, all of which employ physical computer keyboards. It is that field, in particular, to which the present invention is directed.

However, the present invention provides very significant advances for word processors because it will reduce the number of keystrokes required in many instances, and because it does not require awkward key combinations that are unfamiliar or difficult to any person using a QWERTY keyboard, let alone a skilled touch typist. Still further, as will be seen hereafter, the present invention will reduce eyestrain and increased cognitive recognition because, except in certain secondary instances, it does not employ drop-down boxes where suggested words may be displayed. Neither does the present invention require the selection of a device, such as a number key to choose a specific word that has appeared in a drop-down box.

The present inventor has unexpectedly discovered that typing efficiency may be significantly improved, even for persons who are not adept at typing, by the provision of just a few additional keys to a physical computer keyboard, which additional keys will cooperate with resident predictive text software to present reasonable and intelligent suggestions for words or phrases that may be intended. Thus, the present invention preferably employs what is essentially a standard or universal QWERTY keyboard with the addition of several keys (usually four) which can be accessed while the user maintains a standard hand formation such as those known to touch typists, where eight fingers of the two hands rest on a “home row”. Other keyboard layouts can be used in the practise of the present invention, and these keyboards can include layouts such as Dvorak, Cyrillic, foreign language characters, and the like.

It is well known that the thumbs of the two hands are underemployed in typing. The touch typist will use a thumb to actuate the space bar; and the hunt and peck typist will generally only use two or three fingers of one or both hands, but never the thumb. Those shortcomings are overcome by the present invention. Moreover, the present inventor provides that the display fields where predictive text software will make suggestions for the user, are placed on the computer screen in a location where less eyestrain will occur and greater cognitive recognition is possible—it being well known that the human eye perceives objects of any sort in a horizontal field more easily than in a vertical field.

The present invention takes advantage of the fact that, in almost every computer that is available today, there is sufficient memory and/or cache that text prediction software may be resident at all times; and that processors employed in computers are typically quite fast. At least, they are many times faster than any typist can effect keystrokes on a keyboard, so that presentation or display on the computer screen of the characters being typed by actuating keys on the keyboard, is dynamic and in real time. In other words, as a key is actuated, the corresponding character is essentially immediately displayed on the computer screen. Moreover, processing power is such that not only is the last character that was typed shown on the computer screen, there can be dynamic reference to the context in which that character was typed by referring to the previous characters that were typed. This may mean referring to the last 100 or 1000 characters that were typed, or referring to everything that was typed since the last or second last period [“.”] was typed, or since the current paragraph was begun, and so on. In any event, text prediction may, and preferably will, rely at least in part, on the context in which it is being used. Examples will be given hereafter.

### DESCRIPTION OF THE PRIOR ART

Several patents are known which have general relevance to the present invention, in that they relate in one way or another to predictive text population, translation, or input; or relate to a modified QWERTY keyboard which is intended for touch type editing. As will be seen immediately hereafter, none of the known Prior Art is in any way anticipatory or has any specific teachings relative to the present invention.

U.S. Pat. 5,458,425, issued Oct. 17, 1995 to Torok, teaches a keyboard which is intended to provide improved efficiency to touch typists. What this patent teaches is that additional keys may be placed on the keyboard so that they may be easily accessed by the thumbs, so as to replicate or replace keyboard editing keys such as “Escape”, “Insert”, “Page Up”, “Delete”, “Home”, and so on. The patent states that the best way to provide touch editing is by utilizing the thumbs, and thus it places additional keys below the space bar in a location where they may be accessed by the thumbs. However, those additional keys do nothing except provide editing keys whereby the cursor may be moved from one place to another, text may be inserted or deleted, and certain other editing functions may be invoked

Gutowitz was awarded U.S. Pat. No. 6,219,731 on Apr. 17, 2001, for an invention that relates to a method and apparatus for improved multi-tap text input on standard telephone keypads. Prefix information is provided to dynamically reorder keystroke choices so as to reduce the number of manipulations using a standard telephone keypad where the choice of a specific letter is determined by the number of times that a specific key is tapped.

United States Patent Application Publication 2005/0188330, filed by Griffin, was published Aug. 25, 2005, and teaches a predictive text input system for mobile communication device. In this case the mobile device has a reduced-key QWERTY keyboard (such as those sold under the trademark BLACKBERRY). An ambiguous word list and a predictive text system are provided so that keystroke combinations which are present in the ambiguous word list may be associated with more than one predicted word; and if the predictive text system module determines a predicted word for the input keystroke combination, and the input keystroke combination is present in the ambiguous word list, then the predictive text system module will engage an alert mechanism on the mobile device.

Another United States Patent Application Publication filed by Gikandi was published Nov. 16, 2006 as number 2006/0256139. This application teaches a predictive text personal computer simplified keyboard where each key represents several letters and/or characters so that only nine keys are required to represent an entire alphabet of 26 characters. There are screens and selection buttons which combined with predictive text input software such as the T9 dictionary (now superseded by XT9), and the device is said to reduce or avoid frustration of hunting for characters across a keyboard.

U.S. Pat. No. 8,112,708 was issued to Griffin et al on Feb. 7, 2012, and is assigned to Research In Motion Limited. Here, a method and system for populating a predictive text dictionary is provided, where a handheld electronic device and a network are connected one to the other. The user enters text on the handheld device, which has a predictive text dictionary that is operable to receive and employ sets of words. However, user preferences for that specific handheld electronic device are retrieved, so that the predictive text dictionary of the handheld electronic device is populated with a set of words that are at least partially based on the user's preferences.

Finally, U.S. Pat. No. 8,232,973 issued Jul. 31, 2012 to Kocienda et al, and is assigned to Apple Inc. Here, a portable electronic device is shown having a touch screen display including a virtual keyboard. Each key icon has an adjustable size hit region so that receiving a sequence of individual touch points input by a user will determine the character corresponding to a last received individual touch point in accordance with the adjustable hit regions of the displayed key icons. A sequence of characters corresponding to the sequence of individual touch points is displayed, and the sizes of the adjustable hit regions are updated for a plurality of key icons according to the sequence of individual touch points that have been input by the user.

### SUMMARY OF THE INVENTION

In accordance with one aspect of the present invention, there is provided an augmented computer keyboard for inputting text into a computer, where each character of the text being input is displayed on a computer screen in real time as each keystroke is made on the computer keyboard; and wherein the computer preferably includes at least a processor, and memory means and cache means. The computer keyboard has a pre-designated key layout, which preferably is a QWERTY key layout, and at least two additional keys are provided on the computer keyboard, each having selection functionality to select one or another of suggested text strings appearing in selected display fields on the computer screen, there being one display field for each provided additional key. The suggested text strings are presented in the respective selected display fields dynamically and in real time as each keystroke is made, and are chosen from predictive text software running on the computer in the memory means and cache means. It is a feature of the present invention that the additional keys are preferably physically placed so as to be near the space bar on the computer keyboard.

Also, the placement of the additional keys is preferably such that any one of them may be actuated by a thumb of the augmented computer keyboard user.

Moreover, the suggested text strings which appear dynamically in the selected fields on the computer screen may be chosen from the group consisting of words, predetermined phrases, predetermined sentences, predetermined paragraphs, and combinations thereof.

There may be just two additional keys provided, and thus there will be two selected fields on the computer screen corresponding with one or the other of the two additional keys.

While any number of additional keys may be provided, typically the number of additional keys is equal to, or less than eight However, in a preferred embodiment, there are usually four additional keys provided, and thus there are four selected fields on the computer screen corresponding with one or the other of the four additional keys.

Another provision of the present invention is that the additional keys are physically placed on the augmented computer keyboard below the space bar thereof.

Still further, each of the four additional keys may be colour coded with a mutually distinctive colour, in which case each of the four selected fields on the computer screen is also colour denoted with the same colour as the corresponding one of said four additional keys.

In another alternative embodiment, the region ordinarily occupied by a space bar on a QWERTY keyboard is, instead, occupied by a reduced length space bar and at least two additional keys.

In yet another alternative embodiment, the region ordinarily occupied by a space bar on a QWERTY keyboard is, instead, occupied by a reduced length space bar and at least four additional keys.

In another iteration of the present invention, the region that is ordinarily occupied by a space bar on a QWERTY keyboard is, instead, occupied by four additional keys, each having an assigned selection functionality; and the space bar functionality, while inputting text, is achieved by simultaneously actuating two of the additional keys.

The present invention also preferably provides that a predetermined text string may be chosen from a selected field on the computer screen by first typing an acronym for the predetermined text string, and actuating the corresponding additional key.

Also, in certain circumstances, drop-down lists of synonyms or antonyms for each suggested text string that appears on the computer screen may be invoked by pressing at least one indicated secondary key on the augmented computer keyboard, and selection of a desired synonym or antonym may be invoked by pressing the requisite additional key simultaneously with the at least one secondary key on the augmented computer keyboard.

Still further, in keeping with the present invention, actuation of a selected additional key may result in the selected predetermined text string being displayed on the computer screen in the text being typed, and presentation of a new set of suggested text strings will appear in the respective display fields on the computer screen, so that extended text composition may be achieved without the necessity for additional character keystrokes.

In a further embodiment of the present invention, an additional phrase completion key on said computer keyboard may be provided. The further additional phrase completion key has selection functionality to select a predetermined phrase that is embedded in the predictive text software after a requisite initial text string of any predetermined phrase has been input into the predictive text software in real time. Thus, a specific predetermined phrase may be selected by actuation of the additional phrase completion key at the instant in real time that the entire specific predetermined phrase is displayed on the computer screen when the required initial text string for that specific predetermined phrase has been input

The present invention also provides a method of inputting text into a computer, wherein suggested text strings are continuously being displayed in real time on a computer screen as each keystroke is made using predictive text software running on the computer, comprising the steps of:

(a) typing sequential keystrokes on an augmented computer keyboard, preferably having a QWERTY key layout, and having at least two additional keys which are provided on the computer keyboard, where each additional key has selection functionality to select one or another of suggested text strings appearing in selected display fields on the computer screen, there being one display field for each provided additional key; and wherein the suggested text strings are presented in the respective selected display fields dynamically and in real time as each keystroke is made, and are chosen from predictive text software running on the computer, and preferably in the computer's memory means and/or cache means;

(b) actuating a respective one of the additional keys when a required text string appears on the computer screen in a selected display field corresponding to the respective additional key to be activated; and

(c) repeating steps (a) and (b) until the intended text composition is completed.

In general, the suggested text strings which appear dynamically in the selected fields on the computer screen may be chosen from the group consisting of words, predetermined phrases, predetermined sentences, predetermined paragraphs, and combinations thereof.

Moreover, according to one provision of the present invention, a predetermined text string may be chosen from a selected field on the computer screen by first typing an acronym for the predetermined text string, and actuating the corresponding additional key.

Still further, drop-down lists of synonyms or antonyms for each suggested text string appearing on the computer screen may be invoked by pressing at least one indicated secondary key on the augmented computer keyboard, and wherein selection of a desired synonym or antonym may be invoked by pressing the requisite additional key simultaneously with the at least one secondary key on the augmented computer keyboard.

It is also noted that actuation of a selected additional key will result in the selected predetermined text string being displayed on the computer screen in the text being typed, and presentation of a new set of suggested text strings will appear in the respective display fields on the computer screen, so that extended text composition may be achieved without the necessity for additional character keystrokes.

### BRIEF DESCRIPTION OF THE DRAWINGS;

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention.

Embodiments of this invention will now be described by way of example in association with the accompanying drawings in which:

FIG. 1 is a representation of a typical Prior Art QWERTY computer keyboard ;

FIG. 2 is a typical embodiment of an augmented computer keyboard in keeping with the present invention, where the additional keys are placed below the space bar;

FIG. 3 is a further embodiment an augmented computer keyboard which is functionally similar to the embodiment of FIG. 2, except that the additional keys and the space bar are contiguous;

FIG. 4 is a still further embodiment an augmented computer keyboard similar to that of FIG. 3, except that the space bar has been removed from the keyboard;

FIG. 5 shows an augmented computer keyboard in use, with typical text being shown on a computer screen, along with suggested text which has been invoked by the last keystroke on the augmented computer keyboard;

FIG. 6 shows an augmented computer keyboard in use, where alternative synonyms are being suggested as well, each being relative to one of the suggested text words as noted in FIG. 5;

FIG. 7 shows an augmented computer keyboard in use, wherein each of the additional keys has a different colour, and each of the colours of the additional keys is mutually distinctive from each of the other colours; and

FIG. 8 shows an augmented computer keyboard in use having an additional phrase completion key below the other additional keys that are provided.

### DETAILED DESCRIPTION OF THE PREFERRED EMBODIMENTS:

The novel features which are believed to be characteristic of the present invention, as to its structure, organization, use and method of operation, together with further objectives and advantages thereof, will be better understood from the following discussion

In the following discussion, the reader will understand that reference to a computer is not intended to be limiting; however, the present invention particularly lends itself to computers that are known as laptop computers or desktop computers. As is well known to those skilled in the art, a laptop computer is usually relatively lightweight, comprising a computer screen on one half of a folding chassis and a keyboard on the other half of the folding chassis, which are such that when the two halves are folded together the computer screen and computer keyboard are protected, and the device is portable. Desktop computers generally comprise a computer tower in which a processor, memory, cache, disk drives, cooling fans, power supply, etc., are housed. A separate computer keyboard and computer screen are in communication with the computer tower; which communication may be wired or wireless, including Bluetooth. In any event, it is understood that any computer intended to function in association with an augmented computer keyboard in keeping with the present invention will typically include at least a processor, memory means and cache means, and that many kinds of software including a resident operating system, a word processor, predictive text software, etc., may be running simultaneously.

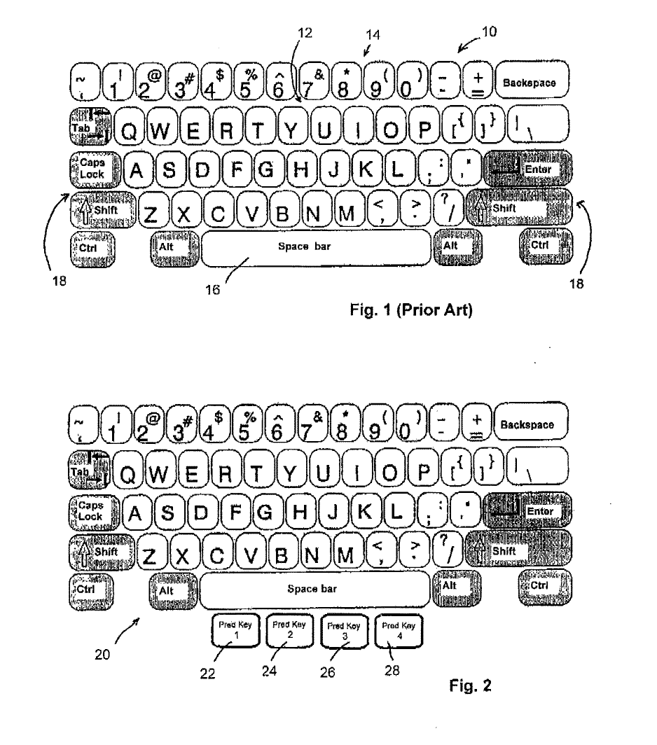

Turning first to a depiction of a Prior Art computer keyboard 10 as it is shown in FIG. 1, the usual layout of a computer keyboard includes a standard QWERTY layout 12, number keys 14, a space bar 16, and cursor control keys identified by reference numeral 18. There is no need for further discussion of such a typical computer keyboard, as it is well known to those skilled in the art.

Referring now to a first embodiment of an augmented computer keyboard in keeping the present invention, such a keyboard is shown at 20 in FIG. 2. It will be seen that the layout is substantially similar to that as shown in FIG. 1, except that four additional keys are added to the keyboard at 22, 24, 26, and 28. Those additional keys may be referred to as “Prediction Keys 1, 2, 3, and 4” respectively. It should be noted that the present invention will allow for only two prediction keys to be provided, but in order to allow for reasonable choice of the suggested text strings which will appear on the computer screen in real time, as discussed hereafter, it is preferred to provide at least four prediction keys.

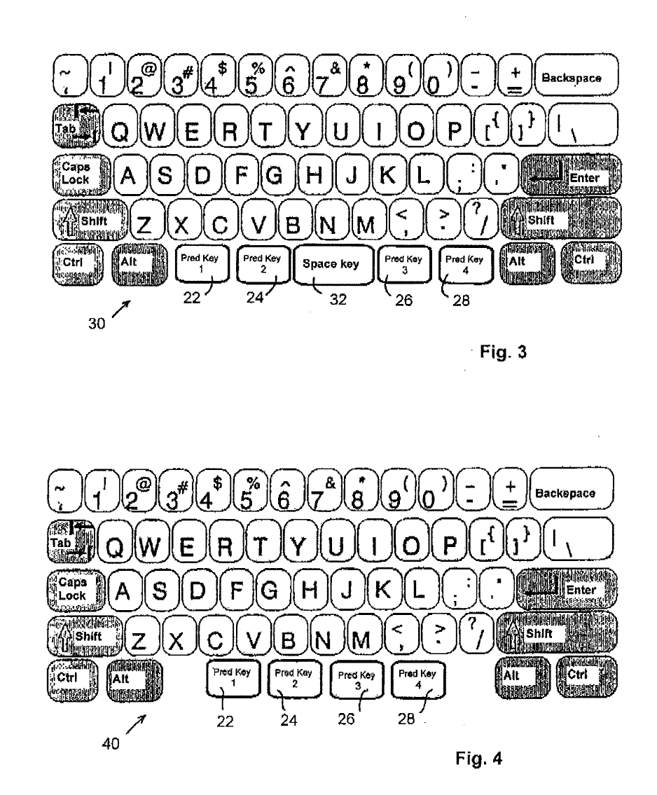

FIG. 3 provides for a more compact augmented computer keyboard 30 by replacing the space bar with five keys, which are functionally a shorter space bar 32, as well as prediction keys 22, 24, 26, and 28. The manner of operation of the augmented computer keyboard, or any of them as disclosed herein, is described and discussed hereafter

In FIG. 4, a further alteration has been made to the augmented computer keyboard 40, by removal of the space bar that would normally be found on any computer keyboard. However, prediction keys 22, 24, 26, and 28 will be found; and it is intended that the function of the missing space bar is achieved by pressing two of the prediction keys 22, 24, 26, and 28 Depending on the specific software that is resident in the computer, it may be that simultaneous actuation of any two of the prediction keys will achieve the space bar functionality; or it may be that only a specified pair of the prediction keys will exhibit the space bar functionality.

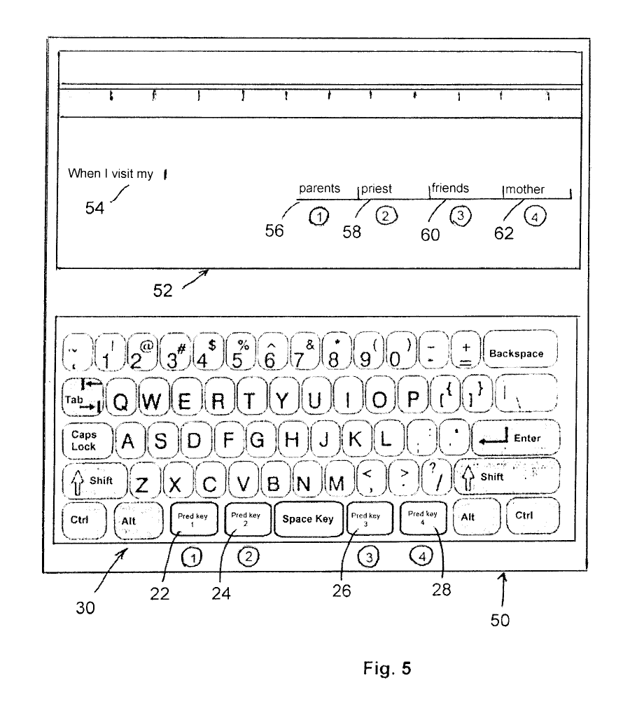

In any embodiment of the present invention, each additional key—the prediction keys—has selection functionality which will select one or another of suggested text strings which appear dynamically in selected display fields on the computer screen, there being one display field for each provided additional key, all as will be described shortly. For example, referring to FIG. 5, a computer 50 is shown, comprising a typical augmented computer keyboard 30 as previously discussed, and a computer screen 52 on which text 54 has been entered. It will be seen that the last portion of that text 54 reads “When I visit my ”. It will also be seen in display boxes 56, 58, 60, and 62, that suggested text words “parents”, “priest”, “friends”, and “mother”, are presented. Moreover, the relationship between the suggested text in the display fields 56, 58, 60, and 62 and the additional keys—the prediction keys—22, 24, 26, and 28, respectively, is shown. Additional key 22 is also identified as Prediction Key #1; and display field 56 is also identified as being Display Field #1. The relationship between the other prediction keys and the other display fields should be obvious to the reader.

Of course, it will also be understood by those skilled in the art that the suggested text strings which appear dynamically in the selected display fields on the computer screen 52 may equally be words, predetermined phrases, predetermined sentences, predetermined paragraphs, and combinations thereof. The suggested text strings may be displayed in a horizontal orientation (as shown), but the use of a listing in a vertical orientation is not excluded. Moreover, it will be understood that, in general, there will be an embedded space character at the end of the selected text string in order for there to be continuity of the text composition. If punctuation is required, it is simply a matter of backspacing the cursor as necessary—a task well known to any typist.

It will be obvious by inspection of any of FIGS. 2 to 8 that the placement of the additional keys 22, 24, 26, and 28, is such that any one of them may be actuated by a thumb of the augmented computer keyboard user. That is because the additional keys 22, 24, 26, and 28 are physically placed on the augmented computer keyboard so as to be near the space bar; and in the case of augmented computer keyboard 40, to replace the space bar. The additional keys are preferably placed near the space bar, meaning that they are operatively adjacent to the space bar, and in a position to be easily actuated by the user's thumbs. Of course, as already noted, while between two and eight additional keys may be provided, it is usual that at least two, and preferably, at least four additional keys will be present It has already been noted that the physical placement of the additional keys may be below the space bar, contiguous to a shorter space bar in the same region ordinarily occupied by a space bar on a QWERTY keyboard, or instead of the space bar in certain embodiments.

Additionally, it will be understood that in a number of circumstances acronyms may be used for the predictive text software running on the computer to provide a string which may be long and/or difficult to type. For example, typing the letters or acronym “ALS” or “als” will result in the suggested text “Amyotrophic Lateral Sclerosis” appearing in one of the display fields 56, 58, 60, or 62. Another medical example may come from typing the acronym “totp” and having the suggested text “total proctocolectomy” appear in one of the display fields. Yet another common example may well be that an acronym such as “BP1” may result in what is commonly referred to as “boilerplate” text of the sort found in legal documents of all kinds.

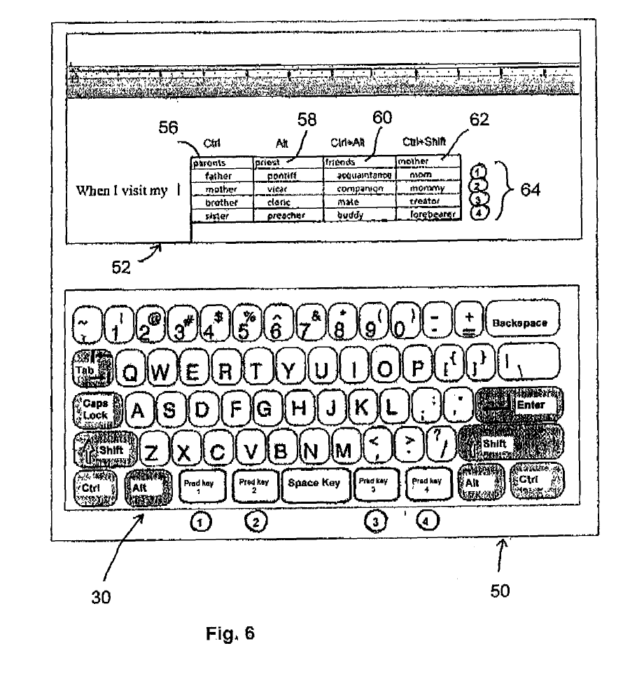

Referring now to FIG. 6, a computer 60 is shown having a software variation of the dynamic, real time, presentation of suggested text is shown In this case, the user may invoke a particular running mode of the resident text prediction software so that synonyms (or, perhaps optionally, antonyms) may appear in the display fields. Here, a matrix 64 of synonyms for the words in display fields 56, 58, 61, and 62 is seen, where the synonyms are shown in columns which appear as drop-down boxes, presented in four rows which are identified as #1, #2, #3, and #4, respectively. However, the columns are also identified and associated with secondary keys which always appear on a computer keyboard; in this case “Ctrl”, “Alt”, “Ctr+Alt”, “Ctrl+Shift”, respectively. Thus, if the user wishes to choose a synonym for any one of the suggested words in the display fields, a particular key combination will be required. For example, if the user wishes to select the word “mate” instead of “friends”, he would simultaneously press the Ctrl key, the Alt key, and prediction key 26 (#3). If the user were to choose “preacher” rather than “priest” appearing in display field 58, the user would simultaneously press the Alt key and the additional key or prediction key 24 (#2). However, it will be noted that invocation of this mode on a computer may depend to some greater or lesser extent on the speed of the processor and the size of the memory and/or cache. Of course, as with all embodiments of the present invention, invocation of all modes of the present invention, the matrix 64 will appear and change in real time as each keystroke is made.

It should also be evident that actuation of any selected additional key 22, 24, 26, or 28, will not only result in the selected text string being displayed on the computer screen in the context of that text which is being typed, but also a new set of suggested text strings will appear in the respect display fields on the computer screen. It may well be that a further suggested text string is one that is intended to be used, so that instead of having to type that text string or at least a few characters thereof, the desired text string may be selected merely by actuating the respective additional key 22, 24, 26, 28. Thus, it is possible that extended text composition may be achieved without the necessity for additional character keystrokes.

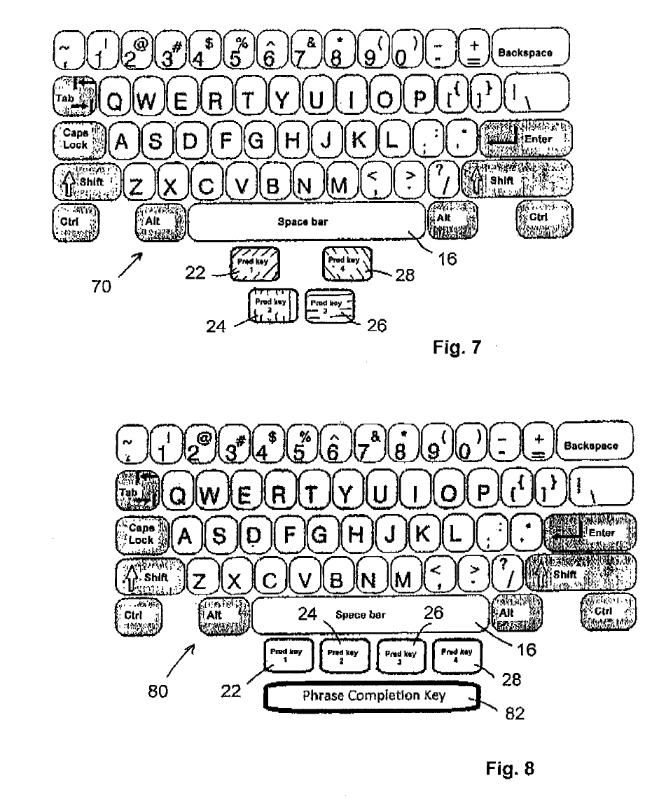

Referring now to FIG. 7, yet another augmented computer keyboard 70 is shown. Here, the placement of the additional keys 22, 24, 26, 28 is different than in other figures, showing that the placement of the additional keys is as much a choice of the designer of the keyboard or of the operator of the keyboard (the typist) who may choose one design of keyboard over another. Further, in FIG. 7, the additional prediction keys 22, 24, 26, 28 are shown as being lined for different colours. At the same time (not shown) each of the four selected fields on the computer screen will also be preferably colour denoted with the same colour as the corresponding one of the additional keys. It should be noted that each of the colours which is used for the additional keys and the corresponding selected fields on the computer screen is mutually distinctive from each of the other colours. The specific colours that may be used are not relevant to the present invention, but as an example colours that can be used include red, green, blue, and yellow; or pink, mauve or purple, chartreuse, and beige.

Turning now to FIG. 8, another augmented computer keyboard 80 is shown. This computer keyboard differs from others that had previously been discussed by the addition of yet another key 82, which is identified as a phrase completion key. In this case, the additional phrase completion key 82 has selection functionality whereby a predetermined phrase may be selected. The predetermined phrase is, of course, one which has been embedded in the predictive text software, and may be selected after a requisite initial text string of any predetermined phrase found embedded in the predictive text software, is entered. The predetermined phrase may be selected by actuating the additional phrase completion key 82 at the instant in real time when the required initial text string for that entire specific predetermined phrase has been input using the keyboard. As an example, when the typist has entered a text string “what now fo”, a predetermined phrase “what now follows” will appear in a specific field therefor on the computer screen. An even more interesting predetermined phrase may be, for example, “the debtor now ag”, giving rise to the phrase “the Debtor now agrees to the following terms and conditions as hereafter stated”.

From the above, it will be clearly understood that typing efficiency of even a novice typist, let alone the efficiency of a skilled touch typist, will be improved by employing an augmented computer keyboard in keeping with the present invention, and as discussed above. This may lead to significant operating cost savings, particularly in large offices such as medical clinics, hospitals, legal firms, engineering firms, and so on.

Moreover, as a typist becomes more familiar with any augmented computer keyboard in keeping with the present invention, the “muscle memory” of the typist improves, so that additional typing speed may be achieved with fewer errors and less hesitation between keystrokes.

It will now be understood that the present invention also provides for a method of inputting text into a computer, wherein suggested text strings are continuously being displayed in real time on a computer screen as each keystroke is made, using predictive text software running on the computer. The steps which comprise that method are:

(a) typing sequential keystrokes on an augmented computer keyboard (20, 30, or 40), preferably having a QWERTY key layout, and having at least two additional keys (22, 24, 26, or 28) which are provided on the computer keyboard, where each additional key has selection functionality to select one or another of suggested text strings appearing in selected display fields (56, 58, 60, or 62) on the computer screen, there being one display field for each provided additional key; and wherein the suggested text strings are presented in the respective selected display fields dynamically and in real time as each keystroke is made, and are chosen from predictive text software running on the computer, preferably in its memory means and/or cache means;

(b) actuating a respective one of the additional keys (22, 24, 26, or 28) when a required text string appears on the computer screen in a selected display field (56, 58, 60, or 62) corresponding to the respective additional key to be activated; and

(c) repeating steps (a) and (b) until the intended text composition is completed.

Obviously, it will be evident from the above discussion that the method of the present invention provides for the suggested text strings which appear dynamically in the selected fields 56, 58, 60, and 62 on the computer screen to be chosen from the group consisting of words, predetermined phrases, predetermined sentences, predetermined paragraphs, and combinations thereof. As also discussed above, a predetermined text string may be chosen from a selected field on the computer screen by first typing an acronym for the predetermined text string, and then actuating the corresponding additional key 22, 24, 26, or 28.

Still further, it will be understood that drop-down list of synonyms are antonyms for each suggested text string may be invoked by pressing at least one indicated secondary key on the augmented computer keyboard, so that a selection of synonyms (or antonyms) may be displayed and a desired synonym (or antonym) may be invoked by pressing the requisite additional key simultaneously with the indicated at least one secondary key on the augmented computer keyboard.

Once again, it will be clearly understood that extended text composition may be achieved without the necessity for additional character keystrokes, as discussed above.

Other modifications and alterations may be used in the design and manufacture of the apparatus of the present invention without departing from the spirit and scope of the accompanying claims.

For example, an ordinary computer keyboard may have an accessory, which comprises a small strip of material, affixed to it; where the strip of material has at least four additional keys—the prediction keys as discussed above. The accessory is in communication with the computer and the already existing computer keyboard, by such as Bluetooth. Thus, legacy keyboards in an office need not be discarded, so long as they are capable in one way or another of communicating with the additional keys that have been affixed thereto

Indeed, the same approach may be made in respect of tablets, which have a virtual keyboard displayed on the screen when they are operating in text entry mode. An accessory as described above may be placed in close proximity to the tablet so as to emulate the placement of the accessory on an ordinary computer keyboard. A skilled typist, in particular, can utilize the additional hardware keys on the accessory in the same manner as discussed above.

Of course, it is usual that any prediction key accessory as noted above will have so-called “soft” keys, but any key structure may be employed as will be evident to those skilled in the art.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, use of the terms “he”, “him”, or “his”, is not intended to be specifically directed to persons of the masculine gender, and could easily be read as “she”, “her”, or “hers”, respectively.

1. An augmented physical computer keyboard for inputting text into a computer, where each character of the text being input is displayed on a separate computer screen in real time as each keystroke is made on the physical computer keyboard;
wherein the physical computer keyboard has a pre-designated key layout;
wherein at least two additional physical keys are provided on said physical computer keyboard, each having selection functionality to select one or another of suggested text strings appearing in selected display fields on the separate computer screen, there being one display field for each provided additional physical key;
wherein the suggested text strings are presented in the respective selected display fields dynamically and in real time as each keystroke is made, and are chosen from predictive text software running on the computer; and
wherein said additional physical keys are physically placed so as to be near the space bar on said physical computer keyboard.

2. (canceled)

3. The augmented physical computer keyboard of claim 1, wherein the suggested text strings which appear dynamically in said selected display fields on said separate computer screen are chosen from the group consisting of words, predetermined phrases, predetermined sentences, predetermined paragraphs, and combinations thereof.

4. The augmented physical computer keyboard of claim 1, wherein the placement of said additional physical keys is such that any one of them may be actuated by a thumb of the physical computer keyboard user.

5. The augmented physical computer keyboard of claim 1, wherein if there are two additional physical keys provided, then there are two selected fields on said separate computer screen corresponding with one or the other of said two additional physical keys; and if there are four additional physical keys provided, then there are four selected fields on said separate computer screen corresponding with one or the other of said four additional physical keys.

6. (canceled)

7. The augmented physical computer keyboard of claim 3, wherein said additional physical keys are physically placed below the space bar thereof.

8. The augmented physical computer keyboard of claim 1, wherein there are four additional physical keys provided, and there are four selected fields on said separate computer screen corresponding with one or the other of said four additional physical keys; and
wherein each of the four additional physical keys is colour coded with a mutually distinctive colour, and each of the four selected fields on the separate computer screen is also colour denoted with the same colour as the corresponding one of said four additional physical keys.

9. The augmented physical computer keyboard of claim 1, wherein said physical computer keyboard is a QWERTY keyboard.

10. The augmented physical computer keyboard of claim 9, wherein the region ordinarily occupied by a space bar on a QWERTY keyboard is, instead, occupied by a reduced length space bar and seven additional physical keys chosen from the group consisting of at least two additional physical keys and at least four additional physical keys.

11. The augmented physical computer keyboard of claim 9, wherein the region ordinarily occupied by a space bar on a QWERTY keyboard is, instead, occupied by four additional physical keys, each having an assigned selection functionality; and
wherein space bar functionality while inputting text is achieved by simultaneously actuating any two of said additional physical keys.

12. (canceled)

13. The augmented physical computer keyboard of claim 3, wherein a predetermined text string may be chosen from a selected field on said separate computer screen by first typing an acronym for said predetermined text string, and actuating the corresponding additional physical key.

14. The augmented physical computer keyboard of claim 3, wherein drop-down lists of synonyms or antonyms for each suggested text string appearing on said separate computer screen may be invoked by pressing at least one indicated secondary key on said augmented physical computer keyboard, and wherein selection of a desired synonym or antonym may be invoked by pressing the requisite additional physical key simultaneously with said at least one secondary key on said augmented physical computer keyboard.

15. The augmented physical computer keyboard of claim 3, wherein actuation of a selected additional physical key will result in the selected predetermined text string being displayed on the separate computer screen in the text being typed, and presentation of a new set of suggested text strings will appear in the respective display fields on the separate computer screen, whereby extended text composition may be achieved without the necessity for additional character keystrokes.

16. The augmented physical computer keyboard of claim 3, further including an additional phrase completion physical key on said physical computer keyboard, wherein said further additional phrase completion physical key has selection functionality to select a predetermined phrase that is embedded in said predictive text software after a requisite initial text string of any predetermined phrase is input into said predictive text software in real time, whereby a specific predetermined phrase may be selected by actuation of said additional phrase completion physical key at the instant in real time that the entire specific predetermined phrase is displayed on said separate computer screen when said required initial text string for that specific predetermined phrase has been input.

17. The augmented physical computer keyboard of claim 1 wherein the computer includes at least a processor, memory means and cache means, and said predictive text software is running on the computer in the memory means and cache means.

18. A method of inputting text into a computer, wherein suggested text strings are continuously being displayed in real time on a separate computer screen as each keystroke is made using predictive text software running on said computer, comprising the steps of:
(a) typing sequential keystrokes on an augmented physical computer keyboard having a predesignated key layout and at least two additional physical keys which are provided on said physical computer keyboard, where each additional physical key has selection functionality to select one or another of suggested text strings appearing in selected display fields on the separate computer screen, there being one display field for each provided additional physical key; and wherein the suggested text strings are presented in the respective selected display fields dynamically and in real time as each keystroke is made, and are chosen from predictive text software running on the computer;
(b) actuating a respective one of said additional physical keys when a required text string appears on said separate computer screen in the selected display field corresponding to the respective additional physical key to be activated; and
(c) repeating steps (a) and (b) until the intended text composition is completed.

19. The method of claim 18, wherein the suggested text strings which appear dynamically in said selected fields on said separate computer screen are chosen from the group consisting of words, predetermined phrases, predetermined sentences, predetermined paragraphs, and combinations thereof.

20. The method of claim 18, wherein a predetermined text string may be chosen from a selected field on said separate computer screen by first typing an acronym for said predetermined text string, and actuating the corresponding additional physical key.

21. The method of claim 18, wherein drop-down lists of synonyms or antonyms for each suggested text string appearing on said separate computer screen may be invoked by pressing at least one indicated secondary key on said augmented physical computer keyboard, and wherein selection of a desired synonym or antonym may be invoked by pressing the requisite additional physical key simultaneously with said at least one secondary key on said augmented physical computer keyboard.

22. The method of claim 18, wherein actuation of a selected additional physical key will result in the selected predetermined text string being displayed on the separate computer screen in the text being typed, and presentation of a new set of suggested text strings will appear in the respective display fields on the separate computer screen, whereby extended text composition may be achieved without the necessity for additional character keystrokes.

23. The method of claim 18, wherein said physical computer keyboard is a QWERTY keyboard.
